(19) United States
(12) Patent Application Publication
(10) Pub. No.: US 2006/0263754 A1
(43) Pub. Date: Nov. 23, 2006

(54) Educational system

(76) Inventor: Ann Brazil, San Marino, CA (US)

Correspondence Address: CHRISTIE, PARKER & HALE, LLP, PO BOX 7068, PASADENA, CA, 91109-7068, US

(21) Appl. No.: 11/351,392

(22) Filed: Feb. 9, 2006

Related U.S. Application Data
(63) Continuation-in-part of application No. 10/681,038, filed on Oct. 7, 2003.
(60) Provisional application No. 60/651,170, filed on Feb. 9, 2005.

(51) Int. Cl. G09B 19/00

(52) U.S. Cl. 434/238

(57) ABSTRACT

A method of educating a child includes identifying a problem behavior exhibited by the child, instructing the child to exhibit improved behavior that is different from the problem behavior, and monitoring the child to detect the improved behavior. After the improved behavior is detected, the method further includes providing a container capable of being opened and closed, providing an inspirational or laudatory message regarding the improved behavior, the message sized to fit within the container, placing the message within the container and closing the container, and hiding the container enclosing the message.

### CROSS-REFERENCE TO RELATED APPLICATIONS

This application claims the benefit of and is a continuation in part of U.S. application Ser. No. 10/681,038, filed Oct. 7, 2003, and claims priority to U.S. Provisional Application Ser. No. 60/651,170, filed on Feb. 9, 2005, and each of which are hereby incorporated by reference as if fully stated herein.

### BACKGROUND OF THE INVENTION

This invention pertains generally to the education of children and more specifically to providing a structured and mediated learning environment for young children.

One method for correcting misbehavior in children includes the use of a “time-out” period. During a time-out period, a child is placed in a quiet environment when the child misbehaves. The child remains in the quiet environment until the child understands the mistake and is ready to apologize for the misbehavior. The length of the time-out period is enforced by an authority figure such as a parent or caregiver with the period adjusted for the child's age. The older the child, the longer the time-out period.

For all young children, the time-out period serves as a “cooling-off” period during which the child calms down until the child is able to control their actions. For young children, a time-out functions very well to immediately correct misbehavior. The young child quickly begins to understand that loss off self-control leads to being placed in a time-out and regaining self-control leads to being able to rejoin the family or group.

As the child matures and gains cognitive skills, the child is expected to not only calm down but to reflect on their own misbehavior during the time-out period. It is hoped that as the child matures, the child begins to understand that the child's misbehavior damages the child's relationships with other children and adults. With the aid of this observation, the child begins to understand that misbehavior is not an arbitrary definition created by a contest of wills between the child and a more powerful authority figure, but that the child's misbehavior results in real harm to the child and the people that the child interacts with.

One problem that may arise with time-outs for the child is that the child may not fully understand why their misbehavior is damaging and may not understand what behavior is expected of them. One way to provide this information is for an authority figure to discuss with the child the child's misbehavior and suggest alternative behaviors. However, the presence of the authority figure during the time-out period may defeat the very purpose of the time-out period, namely providing the child with an opportunity to regain self-control without imposition of control by the authority figure. In addition, the child's misbehavior instigating the need for a time-out period may have included a conflict with the very authority figure that is now trying to educate the child. In this case, the authority figure's presence may cause the child to continue to focus on the events of the conflict rather than focus on ways in which the child may improve their behavior. Finally, the authority figure imposing the time-out period may also be emotionally upset by the child's misbehavior and may not be able to present a rational and calm explanation of the reasons the child's behavior was inappropriate.

Therefore, a need exists for a way to make an educational presentation in a non-threatening manner to a child during a time-out period. Various aspects of the present invention meet such a need.

### SUMMARY OF THE INVENTION

A method of educating a child includes identifying a problem behavior exhibited by the child, instructing the child to exhibit improved behavior that is different from the problem behavior, and monitoring the child to detect the improved behavior. After the improved behavior is detected, the method further includes providing a container capable of being opened and closed, providing an inspirational or laudatory message regarding the improved behavior, the message sized to fit within the container, placing the message within the container and closing the container, and hiding the container enclosing the message.

In one embodiment, the method also includes instructing the child to find the hidden container. A toy figure may also be provided and the container has a shape associated with the toy figure. The toy figure may be a non-threatening authoritative figure, such as a squirrel.

In another embodiment, the method includes providing a second container capable of being opened and closed, providing a second message regarding a location of the hidden container, the second message sized to fit within the second container, placing the second message within the second container and closing the second container, and hiding the second container enclosing the second message.

In yet another embodiment, the child is instructed by selecting through a user interface an educational time-out presentation relating to the problem behavior to present to the child and presenting the educational time-out presentation through a media presentation device to the child, whereby the child is instructed about the problem behavior and the improved behavior.

The educational time-out system may feature a non-threatening, authoritative figure and the shape of the container is associated with the non-threatening, authoritative figure.

### BRIEF DESCRIPTION OF THE DRAWINGS

These and other features, aspects, and advantages of the present invention will be more fully understood when considered with respect to the following detailed description, appended claims, and accompanying drawings, wherein:

FIG. 1 is a block diagram depicting a time-out educational process in accordance with an exemplary embodiment of the present invention;

FIGS. 2a-2d are flow diagrams depicting a time-out educational process in accordance with various exemplary embodiments of the present invention;

FIG. 3a to FIG. 3g include frames from a storyboard for a time-out presentation in accordance with an exemplary embodiment of the present invention; and

FIG. 4 is an architecture diagram of a data processing system suitable for use as a media playback device in accordance with an exemplary embodiment of the present invention.

### DETAILED DESCRIPTION

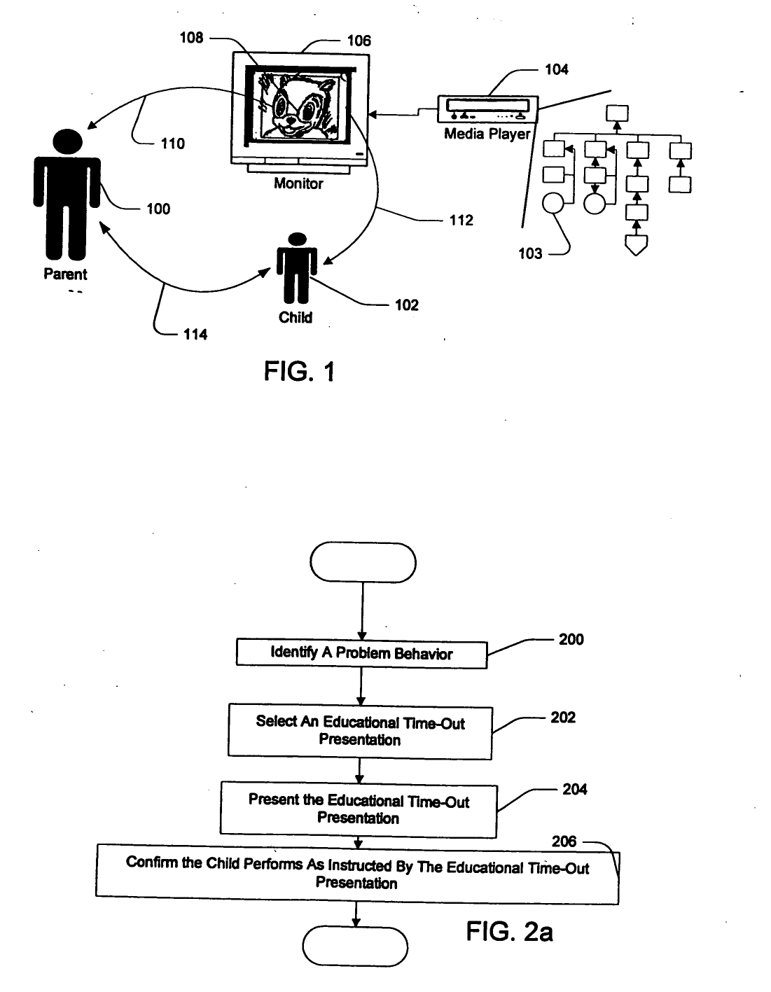

FIG. 1 is a block diagram depicting a time-out educational process in accordance with an exemplary embodiment of the present invention. A caregiver 100, such as a parent or other person responsible for the care of a child 102, identifies a misbehavior in a child. Misbehavior may include minor socially inappropriate actions, such as not taking turns with a toy, to potentially dangerous activities, such as pushing, hitting, or biting another child. The caregiver places the child in a time-out by separating the child from the child's playmates or other distracting environments.

The caregiver selects an educational time-out presentation topic from a plurality of time-out presentation topics presented by a user interface 103 generated by a media player 104, such as a presentation cassette or DVD player, and monitor device 106. Once a topic is selected, by the caregiver, an educational time-out presentation 108 is presented to the child. The educational time-out presentation includes a portion 110 that is intended for the caregiver and a portion 112 that is intended for the child. In the portion intended for the child, a non-threatening authoritative figure 109 offers advice to the child on how to behave in difficult situations. After the child has watched the educational time-out presentation, the caregiver continues to monitor (114) the child's behavior to reinforce the child's good behavior.

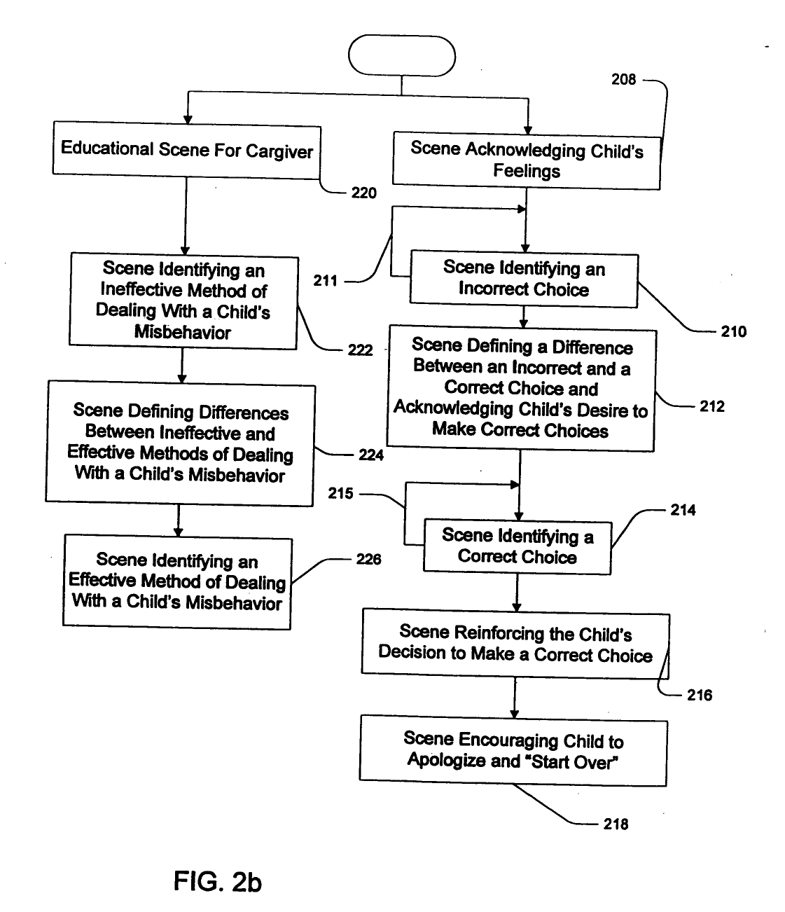

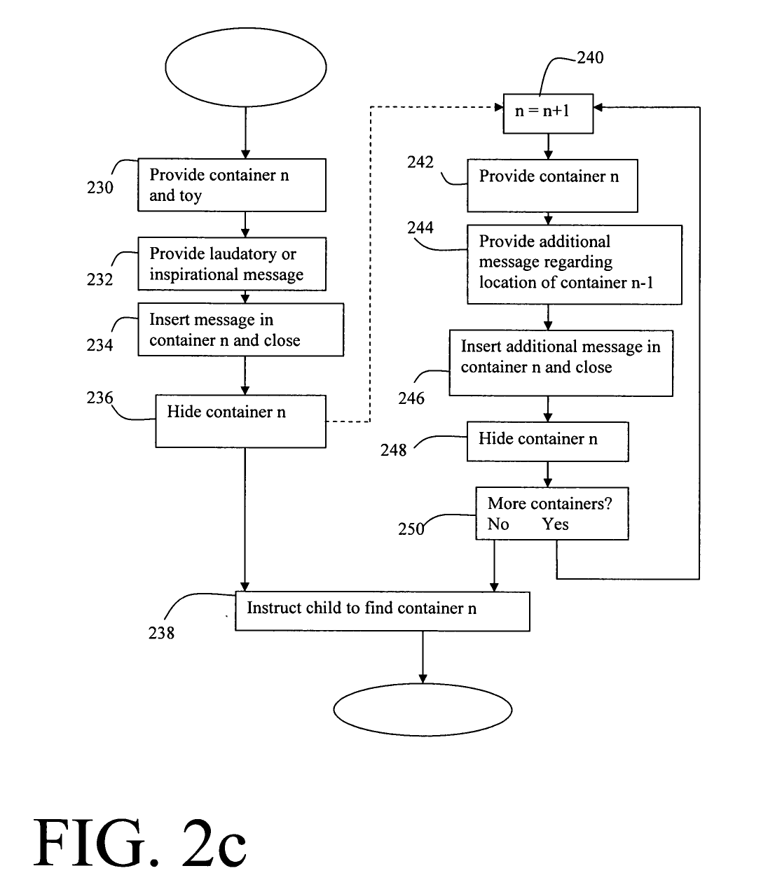

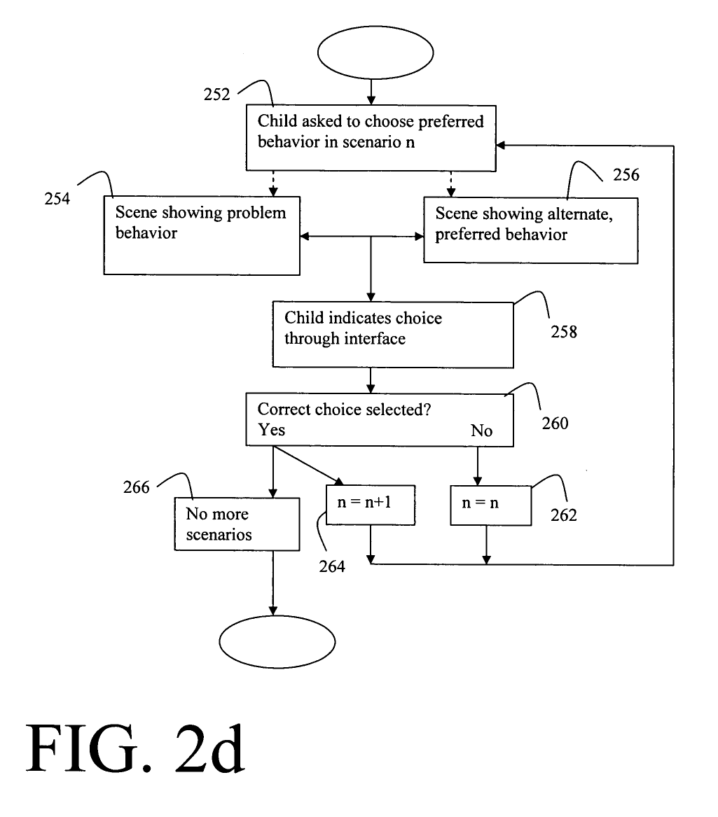

FIG. 2a is a flow diagram depicting a time-out educational process in accordance with an exemplary embodiment of the present invention. A caregiver identifies (200) a problem behavior in a child. The caregiver places the child in time-out. The caregiver then selects (202) an educational time-out presentation to present to the child. Selection of the educational time-out presentation is based on the type of misbehavior by the child. For example, the caregiver may have available a series of themed presentations available. For example, the themes may include pushing, biting, cutting in line, whining, biting, etc. Once an educational time-out presentation has been selected, it is presented (204) to the child. After the child has watched the educational time-out presentation, the caregiver monitors (206) the behavior of the child to confirm that the child is behaving properly.

The structure of the educational time-out presentation reinforces steps in a behavioral modification method used to instruct a child and reinforce the child's commitment to behaving in a socially acceptable manner. In addition to the structure of the presentation, a non-threatening authoritative figure is used to introduce to the child the elements of proper behavior.

FIG. 2b is a process flow diagram for an educational time-out presentation in accordance with an exemplary embodiment of the present invention. The educational time-out presentation includes a scene 208 wherein a non-threatening authoritative figure acknowledges the child's feelings.

Another scene 210 is used to identify the child's incorrect choices. Within the scene, a live-action sequence may be used to illustrate a child in the presentation misbehaving in the same manner as the child in time-out. The scene includes a setup portion indicating a moment in time wherein the child in the presentation must come to a decision about how to behave. The choice made by the child in the presentation leads to another child or a caregiver in the presentation being hurt, angered, or disappointed by the choice made by the child in the presentation. This scene may be repeated (211) a number of times, using different children and scenarios.

In a next scene 212, the non-threatening authoritative figure reminds the child that the illustrated misbehavior leads to negative consequences for the child and reinforces the child's decision to not misbehave.

In another scene 214, the beginning of the misbehavior scene 210 is replayed. However, this time the child in the presentation makes a better decision, leading to greater social acceptance and harmony. This scene may be repeated (215) using different children and scenarios in accordance with the repetition of scene 210.

In a final scene 216, the non-threatening authoritative figure reinforces the child's decision to behave properly by reminding the child of the desirable consequences of behaving well.

As shown in FIG. 2c, if the caregiver determines that the child needs extra encouragement or a reward for behaving well, the caregiver may use a toy version of the non-threatening authoritative figure to reinforce the lessons of the educational time-out presentation 230. One non-threatening authoritative figure in accordance with an exemplary embodiment of the present invention is a squirrel character. A toy version of the squirrel character includes one or more containers shaped like acorns that may be opened and closed 230. A caregiver opens an acorn, and inserts an inspirational or laudatory message 232 for the child, ostensibly from the squirrel character. The acorn may then be closed 234 and “hidden” 236 where the child can find the acorn. Upon finding the acorn after being instructed to find it 238, the child opens the acorn and reads the enclosed message, thus reinforcing the lessons of the time-out educational system.

In addition, a plurality of acorns 240, 242 may be used in a “scavenger hunt” mode. In this mode, each acorn includes a clue 244, 246 instructing the child to proceed to another location in order to find a next clue included in another acorn. Multiple instructions within the acorns are strung together in a sequence 248, 250, thereby teaching the child how to follow multi-step instructions.

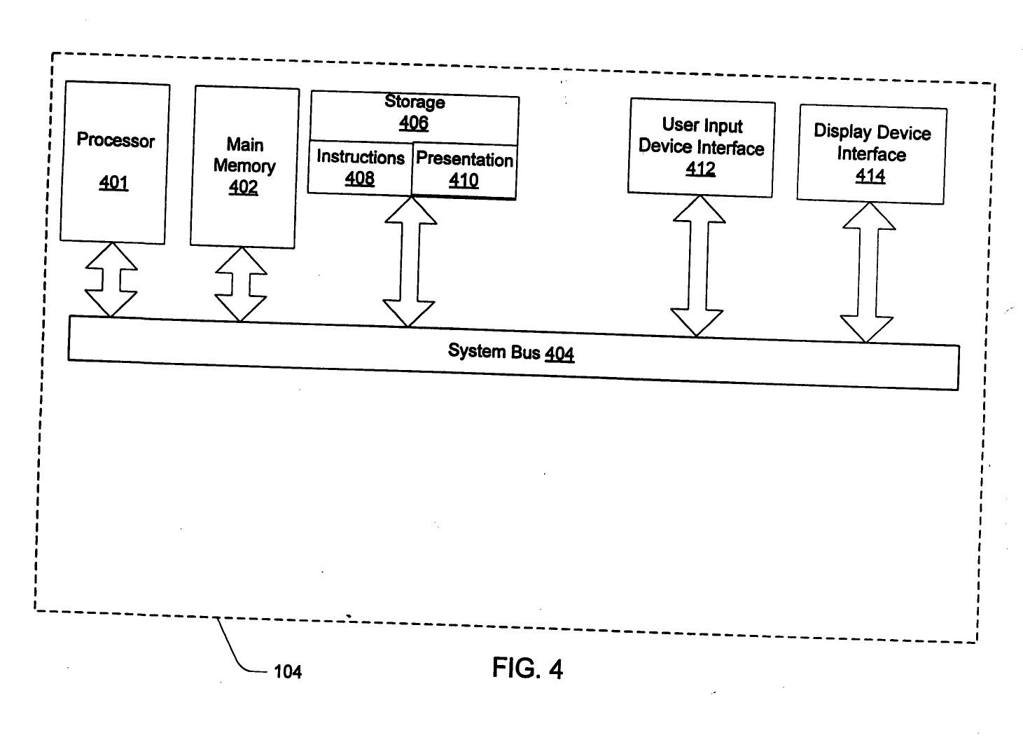

Another reinforcement technique is shown in more detail in FIG. 2d. After viewing the scenes as discussed in FIGS. 2a and 2b, the educational time-out presentation “quizzes” the child through visual and auditory contrasts regarding the problem behavior and the alternate, preferred behavior. Alternate scenes showing different behaviors are presented to the child. In one scene 254, the child featured in the scene exhibits the problem behavior that was the focus of the presentation as discussed in FIGS. 2a and 2b. In another scene 256, the child featured in the scene exhibits the alternate, preferred behavior. The two scenes can be shown to the child in any order, and may be toggled back and forth interactively a user interface (see FIG. 4) by the child. The child observing the scenes is asked 252 by the presentation which of the two scenes indicates the appropriate behavior. The child can then interact with the presentation through the user interface to indicate his or her choice 258. If the choice is incorrect 260, the child can then review the presentation of the scenario again until the child understands the differences in the behavior 262. If the choice is correct 260, the child may then proceed to another scenario regarding the same or different problem behavior 264 until all of the scenarios are completed 266.

For example, a scene in which a child asks for an ice cream cone in a whiny voice can be followed by a scene in which a child asks for the ice cream cone in a “good” voice. The child watching the scenes can then push an arrow button directed to either of the scenes the child believes exhibits the right behavior. In this example, the visual and auditory contrasts can be more clearly understood by the child, and the test may be repeated until the child understands the differences between the problem behavior and the alternate behavior.

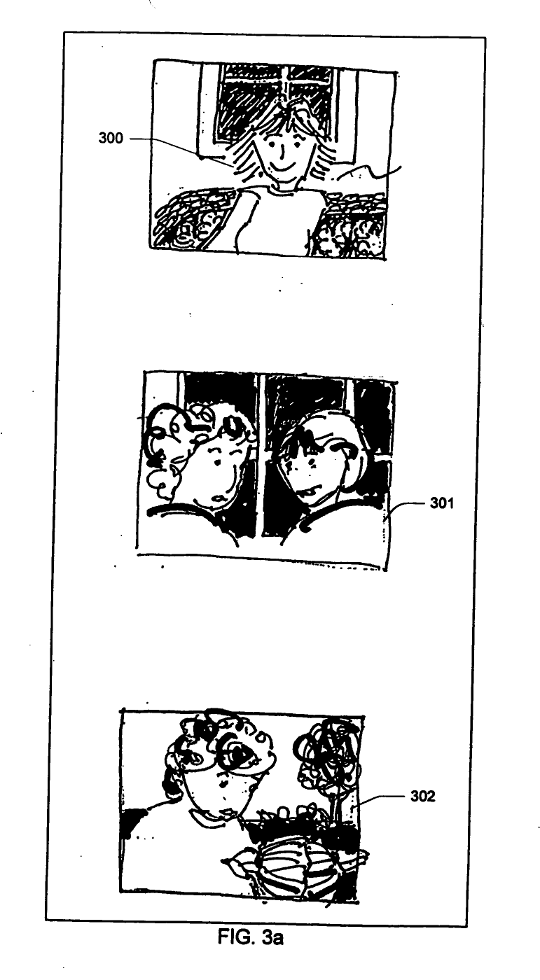

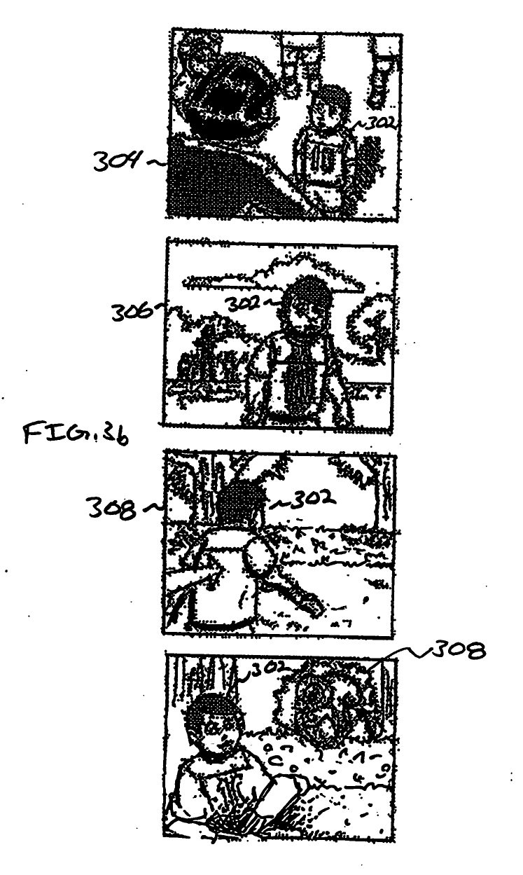

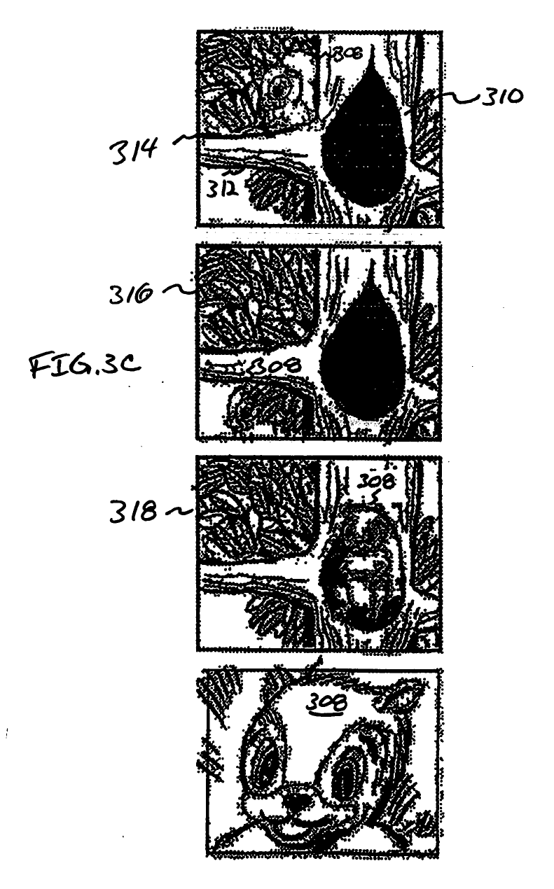

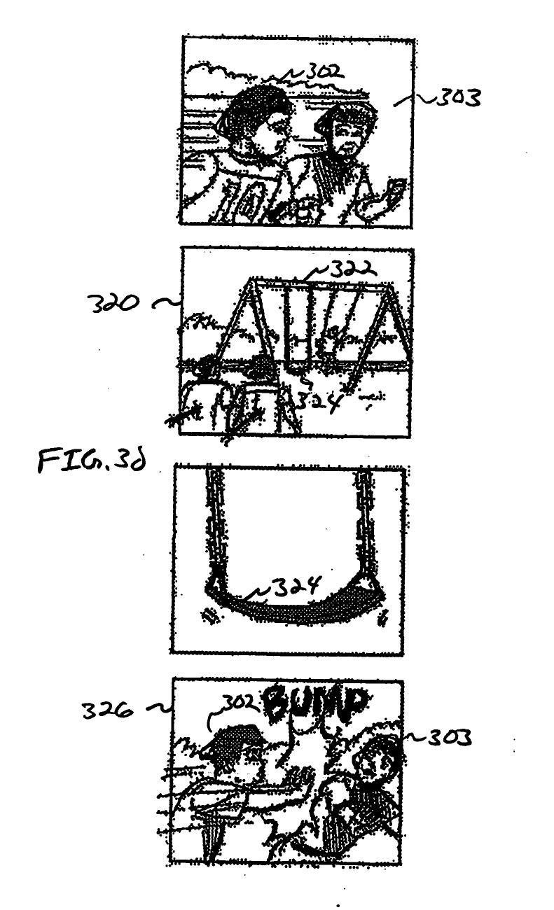

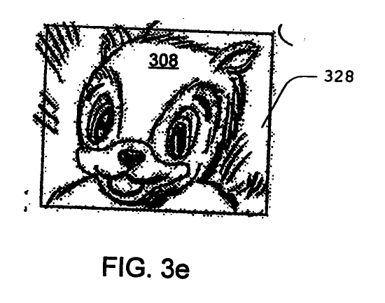

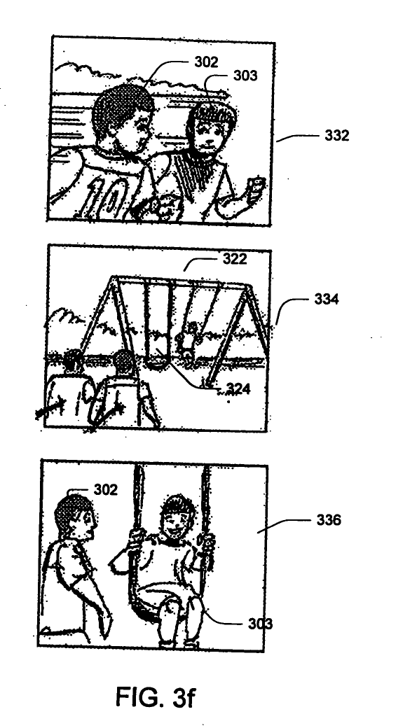

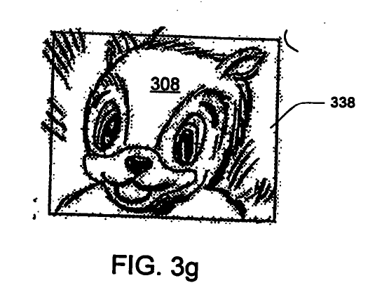

FIG. 3a to FIG. 3g are frames from a storyboard illustrating an exemplary educational time-out presentation in accordance with an exemplary embodiment of the present invention. FIG. 3a is a frame depicting an opening scene of the educational time-out presentation. The intended audience for the opening scene is a caregiver of a misbehaving child. In this scene, an actor 300, playing the part of a concerned caregiver, discusses the structure of the educational time-out presentation and suggests ways that a caregiver may use the educational time-out presentation to educate a child in time-out and reinforce approved behaviors exhibited by the child.

FIG. 3b includes frames from a scene wherein a child 302 is shown receiving a time-out for his misbehavior. The music accompanying the scene includes a theme song having lyrics that reinforce the purpose of the educational time-out presentation. The lyrics are sung by a child in the presentation acknowledging their misbehavior as a mistake and asking guidance from a non-threatening yet authoritative figure as to what a proper behavior may be. During the scene, the child in the presentation accepts imposition of the time-out 304 and separation, 306 and 308, from the play group. At this point, the scene does not reveal what misbehavior resulted in the child in the presentation receiving a time-out.

Near the end of the scene, the non-threatening authoritative figure 308 appears. The non-threatening authoritative figure addresses the camera directly thereby giving the impression that the child in time-out and viewing the presentation is being addressed rather than the child in the presentation. In the exemplary educational time-out presentation, the non-threatening authoritative figure assumes the form of an anthropomorphic squirrel. The non-threatening authoritative figure sings a song with lyrics indicating that the child's misbehavior is a function of the child learning how to behave rather than an inherent feature of the child's personality. The lyrics also reinforce the child's resolve to continue to strive to improve themselves by illustrating that the child has the capacity to learn which is the key to self improvement.

FIG. 3c includes frames from a scene wherein the non-threatening authoritative figure illustrates fallibility, thus illustrating to the child that fallibility is a common characteristic. The scene also reinforces the concept that failure can be overcome through persistence and a resolve to succeed. In the scene, the non-threatening authoritative 308 figure attempts to climb into a hollow 310 of a tree 312. In a first attempt, as illustrated in frame 314, the non-threatening authoritative figure jumps 308 too high and misses the hollow. In a second attempt, as illustrated in frame 316, the non-threatening authoritative figure 308 jumps too low and misses the hollow. In a final attempt, as illustrated in frame 318, the non-threatening authoritative FIG. 308 lands in the hollow.

Near the end of the scene, the non-threatening authoritative FIG. 308 sympathizes with the child. The non-threatening authoritative figure supplies reinforcement for proper behavior by acknowledging that the child is angry and also notes that the child really doesn't want to be angry.

FIG. 3d includes frames depicting a scene wherein the child's particular misbehavior is illustrated. In this scene, the child in the presentation 302 is shown racing with a second child 303. In frame 320, the children reach a swing set 322 with only one free swing 324. In frame 326, the child in the presentation 302 pushes the second child 303 to the ground in order to gain access to the lone remaining swing. This action illustrates the misbehavior for which the child in the presentation received a time-out. As the caregiver has the opportunity to select which of several educational time-out presentations to present to the child, the misbehavior illustrated by the child in the presentation is preferably similar to the misbehavior of the child placed in time-out. Several such scenes may be repeated, each one illustrating specific instances of the particular misbehavior. In each scene, the reaction of a child or caregiver adversely affected by the misbehavior is highlighted so that the child watching the scene will understand that misbehavior affects those around the misbehaving child in an adverse way.

FIG. 3e includes frames from a scene wherein the non-threatening authoritative figure discusses the previous scenes illustrating the particular misbehavior. In frame 328, the non-threatening authoritative figure 308 again addresses the camera directly and recounts the results of the illustrated misbehavior. The non-threatening authoritative figure then states what the child in time-out viewing the previous scene should have learned, namely that a misbehaving child hurts those around the misbehaving child far out of proportion to whatever the misbehaving child may have gained. This leads to the misbehaving child to be unpopular with the misbehaving child's playmates. The non-threatening authoritative figure 308 then states that the child is popular, implying that the child does not misbehave so as to harm the child in time-out's friends.

FIG. 3f includes frames from a scene wherein the child's misbehavior has been corrected. In this scene, as illustrated in frame 332, we see the child in the presentation 302 and the second child 303 racing to a swing set as before. In frame 334, the children in the presentation arrive at the swing set 322 with only one available swing 324 as before. However, in frame 336, the child in the presentation 302 is seen playing cooperatively with the second child 303 on the swing. A scene showing a child's corrected misbehavior is repeated for each scene previously presented illustrating a child's misbehavior.

FIG. 3g includes frames from a scene wherein the non-threatening authoritative figure reinforces a child's decision to behave properly. Again, the non-threatening authoritative figure 308 addresses the camera directly giving the impression the non-threatening authoritative figure is talking directly to the viewing child. In frame 338, the non-threatening authoritative figure 308 reinforces the fact that behaving well will increase the acceptance of the child by the viewing child's playmates. The non-threatening authoritative figure then praises the child for behaving properly.

FIG. 4 is an architecture diagram of a data processing system suitable for use as a media playback device in accordance with an exemplary embodiment of the present invention. A data processing system suitable for use as a media playback device 104 includes a processor 941 coupled to a main memory 402 via a system bus 404. The processor is also coupled to a data storage device 406 via the system bus. The storage device includes programming instructions 408 implementing the features of a time-out presentation as described above. In operation, the processor loads the programming instructions into the main memory and executes the programming instructions to present a time-out presentation 410 stored in the storage device.

The media playback device may further include a user input device interface 412. The media playback device uses the user input device interface to receive selections of time-out presentations from a caregiver.

The media playback device may further include a display device interface 414. The media playback device uses the display device interface to present the time-out presentation to the child as previously described.

Although this invention has been described in certain specific embodiments, many additional modifications and variations would be apparent to those skilled in the art. It is therefore to be understood that this invention may be practiced otherwise than as specifically described. For example, the media used to store and present the educational time-out presentations may be altered without deviating from the spirit of the present invention. Thus, the present embodiments of the invention should be considered in all respects as illustrative and not restrictive, the scope of the invention to be determined by any claims supportable by this application and the claims' equivalents.

What is claimed is:

1. A method of educating a child, comprising:
identifying a problem behavior exhibited by the child;
instructing the child to exhibit improved behavior that is different from the problem behavior;
monitoring the child to detect the improved behavior; and
after the improved behavior is detected:
providing a container capable of being opened and closed;
providing an inspirational or laudatory message regarding the improved behavior, the message sized to fit within the container;
placing the message within the container and closing the container; and
hiding the container enclosing the message.

2. The method of claim 1, further comprising instructing the child to find the hidden container.

3. The method of claim 1, further comprising providing a toy figure, and wherein the container has a shape associated with the toy figure.

4. The method of claim 1, further comprising:
providing a second container capable of being opened and closed;
providing a second message regarding a location of the hidden container, the second message sized to fit within the second container;
placing the second message within the second container and closing the second container; and
hiding the second container enclosing the second message.

5. The method of claim 3, wherein the toy figure is a non-threatening authoritative figure.

6. The method of claim 1, wherein the instructing the child comprises:
selecting through a user interface an educational time-out presentation relating to the problem behavior to present to the child; and
presenting the educational time-out presentation through a media presentation device to the child,
wherein the child is instructed about the problem behavior and the improved behavior.

7. The method of claim 6, wherein the educational time-out presentation features a non-threatening, authoritative figure and wherein a shape of the container is associated with the non-threatening, authoritative figure.

8. A method of educating a child using a media presentation device in communication with a user interface, comprising:
identifying a problem behavior exhibited by the child;
selecting through the user interface an educational time-out presentation to present to the child that corresponds to the problem behavior;
presenting the educational time-out presentation to the child through the media presentation device, the educational time-out presentation including a first scene depicting a second child exhibiting the problem behavior and a second scene depicting the second child exhibiting alternate, preferred behavior;
requesting through the media presentation device an answer input from the child regarding which of the scenes depicts the alternate, preferred behavior; and
accepting the answer input from the child through the user interface.

9. The method of claim 8, further comprising altering an order of display of the scenes based on an input through the user interface.

10. The method of claim 8, further comprising repeating a display of at least one of the scenes based on an input from the user interface.

11. The method of claim 8, further comprising determining the answer input from the child is accurate.

12. The method of claim 11, further comprising repeating the presenting if the answer input is inaccurate.

13. The method of claim 8, wherein at least one of the scenes has an auditory component.

14. The method of claim 8, wherein at least one of the scenes has a visual component.
